(19) United States
(12) Patent Application Publication
(10) Pub. No.: US 2015/0034752 A1
(43) Pub. Date: Feb. 5, 2015

(54) DUAL SELF-WINDING RETRACTABLE DEVICE FOR A WIRE OF A HEADPHONE

(71) Applicants: Miha Homar, (US); Rok Habjan, (US); Igor Angelovski, (US)

(72) Inventor: Miha Homar, Naklo (SI)

(21) Appl. No.: 14/380,648

(22) PCT Filed: Feb. 20, 2013
(86) PCT No.: PCT/SI2013/000008

§ 371 Date: Aug. 22, 2014

(51) Int. Cl. H04R 1/10; B65H 75/44

(52) U.S. Cl. CPC H04R 1/1033; B65H 75/4431; B65H 2701/3919
USPC 242/372; 242/381.6

(57) ABSTRACT

The object of invention is a dual self-winding retractable device for headphone cords, designed in particular for thinner, more delicate cords, and especially adapted for cords of mobile phone headsets, cords of iPod headphones, etc. As invented, the dual self-winding retractable device has two independently moving winding reels (1, 1′) with gearing, whereby each one carries a part of the headphone cord. The winding reels (1, 1′) are housed by a housing case, which consists of two housing lids (2, 2′). A reliable contact is ensured between the two contact discs (7, 7′) which provide electrical contact between both free ends of the headphone cord. Controlled winding/unwinding of each individual part of the headphone cords in enabled through a system of two spiral torsion springs (4, 4′), two buttons (5, 5′) with gearing or two buttons with related retraction (9,9′) and a special spring (8,8′) and two compression springs (6, 6′).

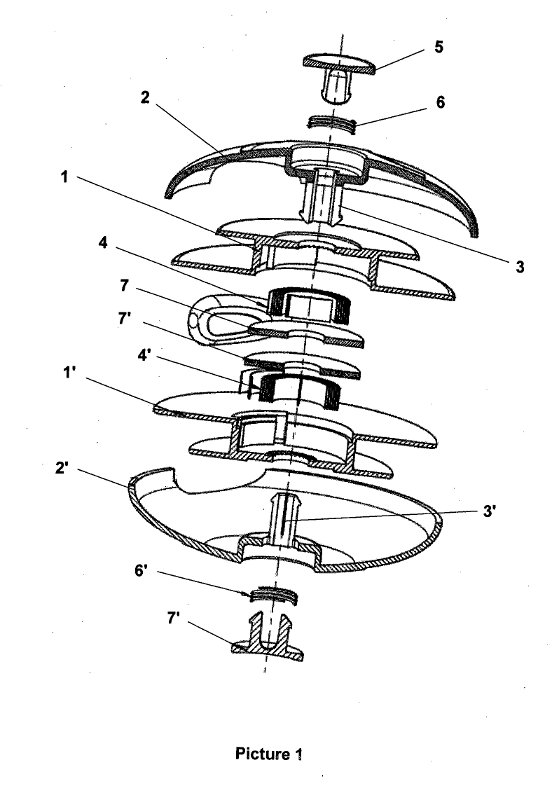

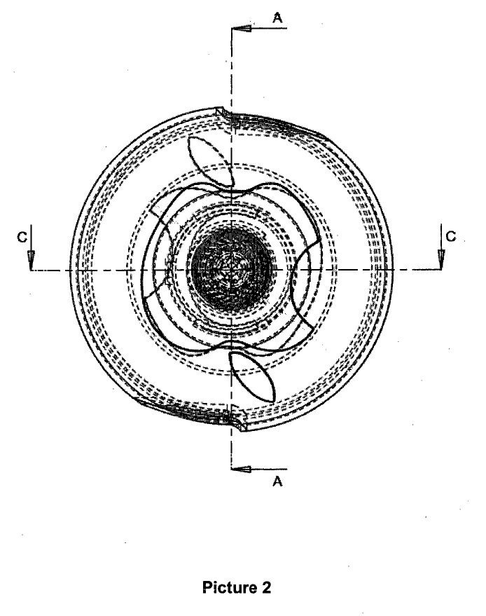

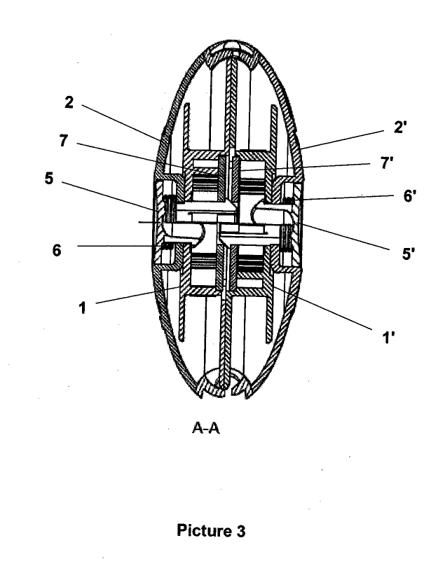

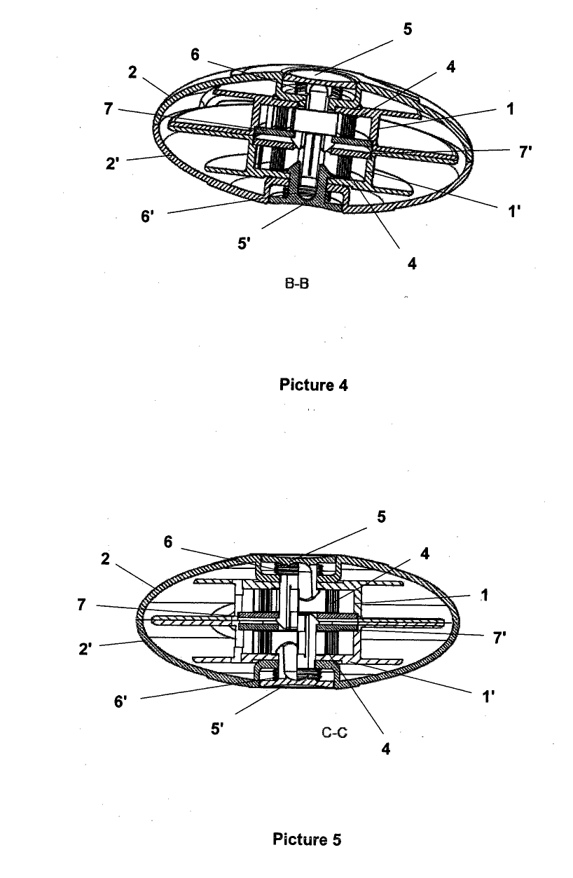

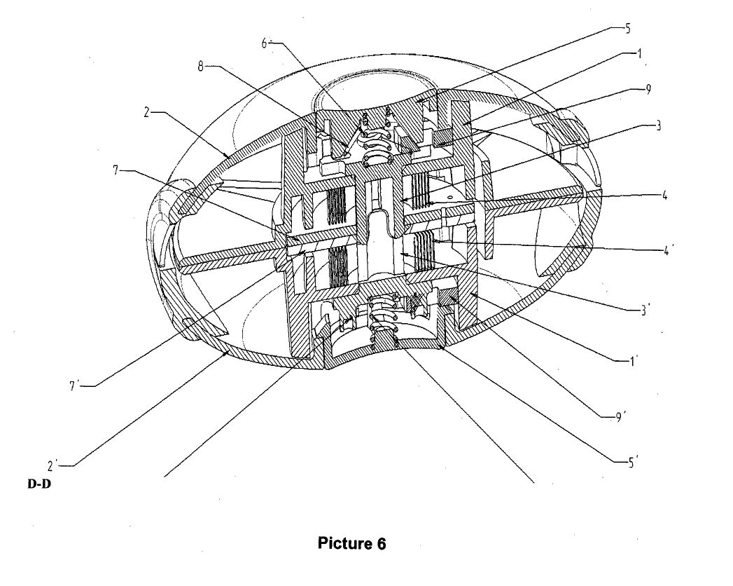

The object of invention is a dual self-winding retractable device for headphone wires (hereinafter referred to as cords), designed in particular for thinner, more delicate cords, and especially adapted for mobile phone headset cords, cords of iPod headphones, and the like.

The invented device consisted of two mutually independent winding reels with gears. Each of the reels enables for one part (the plug-in or the speakers part) to be winded/unwound and both of the winding reels are inserted into a housing case in a way that enables reliable contact between the built-in contact discs, which ensures electric contact for both parts of the headphone cord. Controlled winding/unwinding is enabled with the help of two spiral torsion springs, two buttons with gear (or two buttons with related retraction and a special spring) and two compression springs. The invention is classified under the H04M 1/15 and H02G 11/02 under the International Patent Classification.

The technical problem that the presented construction of a dual self-winding device for headphone cords successfully solves is the construction of a winding device for headphone cords, particularly thinner, more delicate cords, which will enable for a simple and reliable function of (dual) self-winding retraction of a cord with the above mentioned characteristics and with a most rational usage of space.

Market and patent research has shown that some similar systems or devices already exist. The main drawback of these devices, however, is that the system allows for the cord to only be winded/unwound in full and thus does not enable independent control over the length of each part of the cord (the plug-in or speaker part). The latter shortages there do not facilitate a solution for the technical problem in question. In addition, there is currently no dual self-winding system on the market.

As invented the dual self-winding retractable device consists of mutually independent winding reels with gears. Each of the reels enables for one part (the plug-in or the speakers part) to be winded/unwound and both of the winding reels are inserted into a housing case in a way that enables reliable contact between the built-in contact discs, which ensures electric contact for both parts of the headphone cord. Controlled winding/unwinding is enabled with the help of two spiral torsion springs, two buttons with gear (or two buttons with related retraction and a special spring) and two compression springs.

The invention is further explained in detail with use of an operating example and supporting illustrations, as follows:

Picture 1 dual self-winding retractable device for headphone cords as invented in axonometric projection;

Picture 2 dual self-winding retractable device for headphone cords as invented from an overhead perspective;

Picture 3 dual self-winding retractable device for headphone cords as invented from an A-A perspective;

Picture 4 dual self-winding retractable device for headphone cords as invented from an B-B perspective;

Picture 5 dual self-winding retractable device for headphone cords as invented from an C-C perspective;

Picture 6 dual self-winding retractable device for headphone cords as invented from an D-D perspective (with two buttons with related retraction 9,9′ and a special spring 8,8′).

The dual self-winding retractable device for headphone cords as invented enables that only one part of the cord (with mobile phone headsets this is the ‘connecting cord’ which connects the dual self-winding retractable device and the mobile phone) to be retracted only as much as desired, while the rest of the cord rests wound on the winding reel inside the device. By pressing the geared button that is connected to the first winding reel, the cord is easily wound back on the first winding reel.

The second part of the cord that consists of two separate cords (with mobile phone headsets these are the two cords which connect each of the speakers and the dual self-winding retractable device) can be unwound completely independently of the first part of the cord only as much as desired. By pressing the geared button that is connected to the second winding reel, both cords easily wind back on the second winding reel.

As invented the dual self-winding retractable device consists of two independently moving winding reels 1, 1′ with gearing, that are contained inside a housing case which consists of two lids 2, 2′, whereby each of the winding reels caries one parts of the headphone cord. The winding reels 1, 1′ rest on locking parts 3, 3′ of the housing lids 2, 2′. Upon assembly of both housing lids 2, 2′ with the winding reels 1, 1′ and the spiral torsion springs 4, 4′ inserted, an independent movement of both winding reels 1, 1′ is enabled. After attaching both parts of the headphone cord to the winding reels 1, 1′ it is possible to pull out the required amount of the cord on each side. Controlled stopping or releasing (winding and unwinding) of each part of the cord is made possible by two buttons with gearing 5, 5′ (or with two buttons with related retraction 9, 9′ and a special spring 8, 8′, picture 6) that are inserted into the device through suitable aperture in the housing lids 2, 2′ via compression springs 6, 6′.

At the open end each part of the cord is electrically connected to the installed contact discs 7, 7′, which, upon assembly of the dual self-winding retractable device as invented and after the installation of both housing lids 2, 2′, are in mutual electrical contact.

The device, as invented, is physically suitable for use with mobile phones and provides a fast and smooth winding of both pats of the cord due to the design with two independently moving winding reels 1, 1′, whereby each one carries a part of the headphone cord, and the built-in contact discs 7, 7′, which enable for the cord to be divided into two parts.

The dual self-winding retractable device for headphones cord as invented successfully resolves the technical problem in question and offers a practical solution of storing headphones for mobile phones, etc., that allows the user to simply pull out the desired length of both cords and the retract them by simply pushing both buttons, ensuring knot- and tangle-free storage.

1. Dual self-winding retractable device comprising:
two independently moving and locking winding reels with gearing inserted into a housing case, wherein the housing case comprises two lids that rest on a plurality of locking parts;
two spiral torsion springs that are inserted into the winding reels, which allows for an electrical contact between a plurality of installed contact discs and between both free ends of a headphone cord;
wherein controlled winding/unwinding of each individual part of the headphone cord occurs through a system of two spiral torsion springs, two buttons with gearing or two buttons with related retraction and a special spring and two compression springs.

2. A dual self-winding retractable device comprising:
a plurality of lids that when brought together form a case for housing headphone cords, wherein the headphone cords comprise at least two parts;
a plurality of independent winding reels that each carry one part of the headphone cords, each winding reel corresponding to one of the plurality of lids and having its own gearing that is inserted into the case, such that the winding reels are independently locked and moved to thereby provide independent control over the length of the two parts of the headphone cords;
a plurality of compression springs, wherein one compression spring corresponds with one winding reel;
a plurality of buttons that correspond with one winding reel, wherein each of the plurality of buttons are in mechanical communication with corresponding gearing, a retraction mechanism, and a special torsional spring; and
wherein depressing one of the plurality of buttons loads the corresponding compression spring and activates the corresponding retraction mechanism, thereby releasing the corresponding winding reel and causing said winding reel to independently rotate thereby winding or unwinding one part of the headphone cord; and
wherein releasing said one of the plurality of buttons releases the load in the corresponding compression spring, thereby independently locking the corresponding winding reel such that one part of the headphone cord is locked in place.

3. The device of claim 2, wherein the plurality of lids rest on and are in mechanical communication with a plurality of locking parts.

4. The device of claim 3, wherein the headphone cord comprises two free ends, and wherein the device further comprises a plurality of spiral torsional springs that are inserted into the winding reels, such that the spiral torsional springs exert a force to thereby allow for an electrical contact between a plurality of contact discs and the two free ends of the headphone cord.

5. The device of claim 2, wherein the device further comprise a plurality of spiral torsional springs, wherein one spiral torsional spring corresponds with one winding reel.

6. The device of claim 2, wherein each of the winding reels rests on a corresponding locking part of the housing lid.

7. The device of claim 2, wherein upon assembly of the plurality of housing lids with the corresponding winding reels and with the spiral torsion springs being inserted into said winding reels, there is independent movement of the winding reels.

8. The device of claim 7, wherein after attaching the parts of the headphone cord to the winding reels the cord is allowed to be pulled out to a desired amount on each side.

9. A dual self-winding retractable device comprising:
a case that comprises a plurality of lids that when brought together form a housing for a headphone cord, wherein the headphone cord comprises at least two parts;
two independent winding reels, wherein each winding reel carries one part of the headphone cord, such that the winding reels are independently locked and moved to thereby provide independent control over the length of the two parts of the headphone cord;
two compression springs, wherein one compression spring corresponds with one winding reel; and
two buttons, wherein each button corresponds with one winding reel, and wherein each of the buttons is in mechanical communication with corresponding retraction mechanism, such that depressing one of the buttons loads the corresponding compression spring and activates the corresponding retraction mechanism, thereby releasing the corresponding winding reel and causing said winding reel to independently rotate thereby independently winding or unwinding one part of the headphone cord.

10. The device of claim 9, wherein the plurality of lids rest on and are in mechanical communication with a plurality of locking parts.

11. The device of claim 10, wherein the headphone cord comprises two free ends, and wherein the device further comprises a plurality of spiral torsional springs that are inserted into the winding reels, such that the spiral torsional springs exert a force to thereby allow for an electrical contact between a plurality of contact discs and the two free ends of the headphone cord.

12. The device of claim 9, wherein the device further comprises a plurality of spiral torsional springs, wherein one spiral torsional spring corresponds with one winding reel.

13. The device of claim 9, wherein each of the winding reels rests on a corresponding locking part of the housing lid.

14. The device of claim 9, wherein upon assembly of the plurality of housing lids with the corresponding winding reels and with the spiral torsion springs being inserted into said winding reels, there is independent movement of the winding reels.

15. The device of claim 14, wherein after attaching the parts of the headphone cord to the winding reels the cord is allowed to be pulled out to a desired amount on each side.

16. The device of claim 9, wherein each winding reel corresponds to one of the plurality of lids and has its own gearing that is inserted into the case.

17. The device of claim 9, wherein each of the buttons is in mechanical communication with corresponding gearing, the retraction mechanism, and a special torsional spring.

18. The device of claim 17, wherein releasing one of the buttons releases the load in the corresponding compression spring, thereby independently locking the corresponding winding reel such that one part of the headphone cord is locked in place.
